(19) United States
(12) Patent Application Publication
(10) Pub. No.: US 2025/0282069 A1
(43) Pub. Date: Sep. 11, 2025

(54) ELECTRIC CUTTER OF HAIR-LIKE BODY

(71) Applicant: MAXELL IZUMI CO., LTD., Matsumoto-shi (JP)

(72) Inventor: Hideaki KOIKE, Matsumoto-shi (JP)

(21) Appl. No.: 19/044,629

(22) Filed: Feb. 4, 2025

(30) Foreign Application Priority Data
Mar. 11, 2024 (JP) 2024-037486

(51) Int. Cl. B26B 19/14; B26B 19/38

(52) U.S. Cl. CPC B26B 19/141; B26B 19/3886

(57) ABSTRACT

An electric cutter of a hair-like body according to the present invention includes an inner blade that is rotatable in a forward/rearward direction. The inner blade has a plurality of small blades in which a first blade edge is formed on a forward rotation side and a second blade edge is formed on a rearward rotation side. The electric cutter further includes switching means for switching rotation directions of the inner blade to switch between a first mode in which a hair-like body is cut by the first blade edge and a second mode in which the hair-like body is cut by the second blade edge. A rotation speed of the inner blade in the second mode is set to be higher than a rotation speed of the inner blade in the first mode.

### CROSS-REFERENCE TO RELATED APPLICATION

This application is based upon and claims the benefit of priority of the prior Japanese Patent Application No. P2024-037486, filed on Mar. 11, 2024, and the entire contents of which are incorporated herein by reference.

### TECHNICAL FIELD

The present invention relates to an electric cutter of a hair-like body.

### BACKGROUND ART

In the present application, the term “hair-like body” refers to a hair-like object, and specific examples thereof include human hairs, beards, animal hairs, clothing lint, and the like.

As an example, an electric cutter (as a specific example, an “electric shaver”) of a hair-like body (as a specific example, beards) is known which includes an outer blade having a plurality of hair-like body inlets and an inner blade rotating while coming into sliding contact with an inner surface of the outer blade, and which cuts the hair-like body entering the hair-like body inlet (refer to PTL 1: JP-A-2007-135991).

As another example, an electric cutter (as a specific example, “electric lint remover”) of a hair-like body (as a specific example, lint) is known which includes an outer blade having a plurality of hair-like body inlets and an inner blade rotating while coming into sliding contact with an inner surface of the outer blade, and which cuts the hair-like body entering the hair-like body inlet (refer to PTL 2: JP-A-2015-224396).

### SUMMARY OF INVENTION

### Technical Problem

In the electric cutters of the hair-like body described as examples in PTL 1 and PTL 2, cutting quality of the hair-like body can be improved. However, in some cases, the inner blade damages a “base portion” of the hair-like body (as a specific example, the “base portion” is “skin” when the hair-like body is the beard or the hair, and the “base portion” is “a fabric of clothing” when the hair-like body is a lint). In this invention, examples of the hairs include beards, mustache, whisker, and the like. Therefore, the present inventor has developed an electric cutter of a hair-like body which includes an inner blade rotatable in a forward rotation direction and a rearward rotation direction and which includes a mode with satisfactory cutting quality and a mode in which damage to the base portion can be suppressed (refer to PTL 3: JP-A-2015-223315).

In addition, the present inventor has further studied a configuration in which the cutting quality can be improved while damage to the base portion is suppressed.

### Solution to Problem

That is, an object of the present invention is to provide an electric cutter of a hair-like body which includes a mode in which an inner blade is rotated forward to emphasize improvement of cutting quality and a mode in which cutting quality can be improved to such a degree that the cutting quality is not significantly inferior to the cutting quality in the forward rotation while the inner blade is rotated rearward to emphasize suppressing damage to a base portion.

An electric cutter of a hair-like body according to an embodiment includes a blade unit having an outer blade having a plurality of hair-like body inlets, and an inner blade rotating while coming into sliding contact with an inner surface of the outer blade. The inner blade has a plurality of small blades, and is provided to be rotatable in a forward rotation direction and a rearward rotation direction. The small blade has a first blade edge configured to cut a hair-like body entering the hair-like body inlet on a tip side in the forward rotation direction of an upper end portion, and has a second blade edge configured to cut the hair-like body entering the hair-like body inlet on a tip side in the rearward rotation direction of the upper end portion. The electric cutter further includes switching means for switching rotation directions of the inner blade to switch between a first mode in which the hair-like body is cut by the first blade edge and a second mode in which the hair-like body is cut by the second blade edge. A rotation speed of the inner blade in the second mode is set to be higher than a rotation speed of the inner blade in the first mode.

According to this configuration, it is possible to realize an electric cutter of a hair-like body which can cut the hair-like body by emphasizing cutting quality improvement in forward rotation (first mode), and which can cut the hair-like body to such an extent that the cutting quality is not significantly inferior to the cutting quality of the first blade edge while emphasizing suppressing damage to a base portion in rearward rotation (second mode).

In addition, it is preferable that the small blade is formed such that an angle β of a rake angle of the first blade edge is a relatively small angle, and is formed such that an angle γ of a rake angle of the second blade edge is a relatively large angle.

In addition, it is preferable that the small blade is formed such that the angle β of the rake angle of the first blade edge is an acute angle, and is formed such that the angle γ of the rake angle of the second blade edge is an obtuse angle.

In addition, it is preferable that the rotation speed of the inner blade in the second mode is set to be 1.2 to 1.8 times the rotation speed of the inner blade in the first mode.

### Advantageous Effects of Invention

According to the present invention, it is possible to realize an electric cutter of a hair-like body which includes an inner blade rotatable in a forward rotation direction and a rearward rotation direction, and which includes a mode in which cutting quality is satisfactory and a mode in which damage to a base portion can be suppressed and the cutting quality is not significantly inferior. Therefore, it is possible to realize cutting suitable for a user's preference, a hair-like body, and a state of a base portion by using only one type of the inner blade.

### BRIEF DESCRIPTION OF DRAWINGS

FIG. 1 is a schematic view (perspective view) illustrating an example of an electric cutter of a hair-like body according to a first embodiment of the present invention.

FIG. 2 is a schematic view (exploded perspective view) illustrating an example of a head unit of the electric cutter of the hair-like body illustrated in FIG. 1.

FIG. 3 is a schematic view (perspective view) illustrating an example of an inner blade of the electric cutter of the hair-like body illustrated in FIG. 1.

FIG. 4A is a schematic view illustrating an example of a small blade of the inner blade illustrated in FIG. 3, and FIG. 4B is an enlarged view of a portion A in FIG. 4A.

FIG. 5 is a block diagram mainly illustrating a control unit of the electric cutter of the hair-like body illustrated in FIG. 1.

FIG. 6 is a schematic view (perspective view) illustrating another example of the inner blade of the electric cutter of the hair-like body illustrated in FIG. 1.

FIG. 7A is a schematic view illustrating an example of the small blade of the inner blade illustrated in FIG. 6, and FIG. 7B is an enlarged view of a portion B in FIG. 7A.

FIG. 8 is a schematic view (perspective view) illustrating an example of an electric cutter of a hair-like body according to a second embodiment of the present invention.

FIG. 9 is a schematic view (exploded perspective view) illustrating an example of the electric cutter of the hair-like body illustrated in FIG. 8.

FIG. 10 is a schematic view (perspective view) illustrating an example of the inner blade of the electric cutter of the hair-like body illustrated in FIG. 8.

FIG. 11A is a schematic view illustrating an example of the small blade of the inner blade illustrated in FIG. 8, and FIG. 11B is an enlarged view of a portion C in FIG. 11A.

### DESCRIPTION OF EMBODIMENTS

### First Embodiment

Hereinafter, a first embodiment of the present invention will be described in detail with reference to the drawings. As an example of an electric cutter 1 (1A) of a hair-like body according to the present embodiment, an “electric shaver” when the hair-like body as a cutting target is a “beard” will be described.

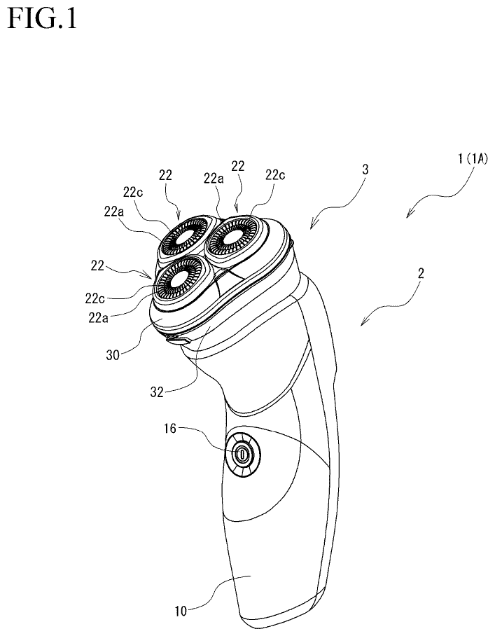

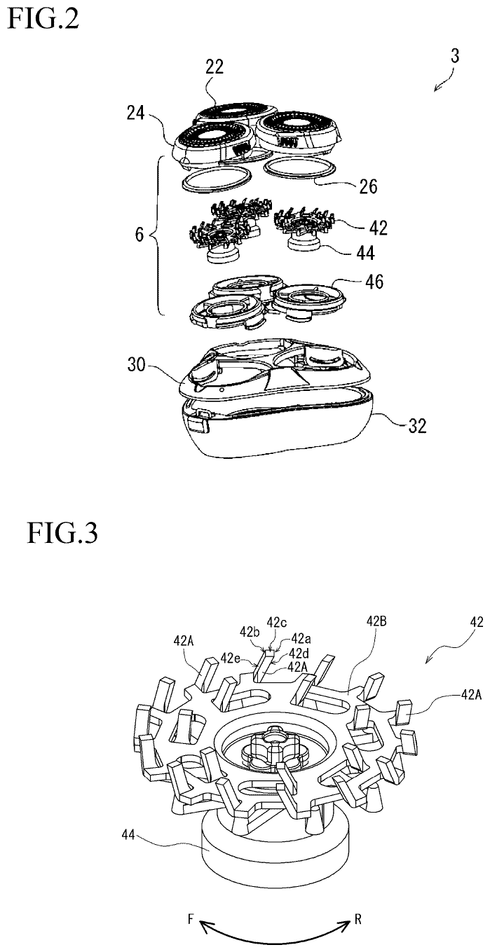

FIG. 1 is a schematic view (perspective view) illustrating an example of the electric cutter 1 (1A) of the hair-like body according to the present embodiment. In addition, FIG. 2 is a schematic view (exploded perspective view) illustrating an example of a head unit 3 of the electric cutter 1 (1A) of the hair-like body. In all drawings for describing the embodiments, the same reference numerals will be assigned to members having the same function, and repeated description thereof may be omitted in some cases.

As illustrated in FIGS. 1 and 2, the electric cutter 1 (1A) of the hair-like body according to the present embodiment has an outer blade 22 in which many hair-like body inlets 22c are formed to penetrate through the outer blade 22, and an inner blade 42 rotating while coming into sliding contact with an inner surface 22b of the outer blade 22, and is configured to cut the hair-like body X entering the hair-like body inlet 22c by using the outer blade 22 and the inner blade 42. Although the electric cutter of the hair-like body which includes three sets of blade units 6 configured to include the outer blade 22 and the inner blade 42 will be described as an example, the present invention is not limited thereto.

In FIG. 1, a reference numeral 2 represents a main body, and a substantially columnar case 10 is provided. A switch 16 for turning on and off power and switching a usage mode is provided on a front surface of the case 10.

Meanwhile, the case 10 internally accommodates a motor 60 that rotationally drives the inner blade 42, a battery that supplies power to the motor 60, and a control unit 50 that performs a series of controls for rotationally driving the motor 60, and the like (FIG. 5 illustrates an example of a block diagram). As an example, the control unit 50 is provided with a switching circuit 52 that switches polarities of the motor 60, and a signal output unit (for example, an IC chip such as a microcomputer) 54 that outputs a signal for switching the polarities of the motor 60 to the switching circuit 52.

As illustrated in FIG. 2, the head unit 3 includes a head case 32 connected to and held on an upper portion of the case 10 of the main body 2, a blade frame 30 covering the head case 32 from above, a drive mechanism (not illustrated) accommodated in an inner bottom portion of the head case 32, and three sets of blade units 6 held on the blade frame 30 to be slightly movable upward and downward and swingable. Here, each of the blade units 6 includes a substantially disk-shaped outer blade 22 and the inner blade 42 rotating while coming into sliding contact with the inner surface 22b of the outer blade 22. In addition, the three sets of blade units 6 are disposed to form a triangle in a plan view. Although the present embodiment is an example when three sets of the blade unit 6 are provided as described above, a basic configuration may be similarly conceivable even when the number of sets of the blade units is other than three.

Here, the outer blade 22 is formed so that hair-like body inlets (as an example, many radial slits) 22c penetrate in an axial direction (that is, the same direction as the axial direction of a rotary shaft of the inner blade 42), and the inner blade 42 cuts the hair-like body X entering the hair-like body inlet 22c (hair-like body inlet 22c may have any configuration other than the slit). That is, the outer blade 22 is configured such that an upper surface (outer surface) 22a serves as a hair-like body contact surface that comes into contact with a base portion of the hair-like body, and the hair-like body inlet 22c is open to the upper surface 22a. For example, the upper surface 22a is formed in an annular plane. In addition, the outer blade 22 has a shape in which a peripheral edge is bent downward, and an outer blade ring 24 is fitted to the peripheral edge. The outer blade 22 is fixed to the outer blade ring 24 by fitting a stopper ring 26 into an inner periphery of the outer blade ring 24.

Meanwhile, the inner blade 42 is fixed to an inner blade holding base 44, and a recess portion into which an upper end of an inner blade drive shaft (not illustrated) connected to an output shaft of the motor 60 is fitted is formed in a lower portion of the inner blade holding base 44. The inner blade 42 is held by an inner blade receiver 46 fitted into the outer blade ring 24 to be swingable toward the outer blade 22 side, and in this manner, three sets of independent blade units 6 are formed.

Since the blade unit 6 is assembled according to the above-described configuration, the inner blade 42 (a small blade 42A to be described later) is in a state of being in contact with the outer blade 22 (inner surface 22b to be described later). In this state, since the inner blade 42 is rotationally driven, the blade edge of the inner blade 42 (small blade 42A) can cut the hair-like body X entering the hair-like body inlet 22c (details will be described later).

Here, as a characteristic configuration of the present embodiment, the inner blade 42 is provided to be rotatable in a forward rotation direction and in a rearward rotation direction. Furthermore, a configuration is adopted in which switching means can switch rotation directions of the inner blade 42 to switch between a first mode in which the hair-like body X is cut by a blade edge (first blade edge 42a to be described later) on a tip side in the forward rotation direction and a second mode in which the hair-like body X is cut by a blade edge (second blade edge 42b to be described later) on a tip side in the rearward rotation direction.

The switching means according to the present embodiment is configured to include the switch 16 and the control unit 50. For example, a signal corresponding to a switching operation (operation position) of the switch 16 is transmitted directly or via a signal output unit 54 to the switching circuit 52, and the switching circuit 52 switches polarities of the motor 60 to switch the rotation directions of the inner blade 42.

More specifically, a configuration is adopted as follows. An electrical contact between the switch 16 and the control unit 50 is provided. A signal is output to the switching circuit 52 directly or via the signal output unit 54 by the switching operation of the switch 16, and power is supplied (power is turned on and off) from a battery to the motor 60 and the polarities of the motor 60 are switched in accordance with the signal. In the motor 60, since the polarities are switched, the rotation directions of the rotary shaft (not illustrated) of the motor 60 as an output shaft are switched between the forward rotation direction (one direction) and the rearward rotation direction (the other direction) opposite to the forward rotation direction. As an example, the rotation speeds of the rotary shaft of the motor 60 in the forward rotation and in the rearward rotation are set to the same rotation speed. However, the different rotation speeds may be set.

The switch 16 is an operation switch for turning on and off the power and switching a usage mode. As an example, a push-type switch can be used. For example, the switch 16 can be set as follows. When the switch 16 is pushed once, the power is turned on, and driving starts in a first mode (details will be described later). When the switch 16 is further pushed once more (twice in total), driving starts in a second mode (details will be described later). When the switch 16 is further pushed once more (three times in total), the power is turned off to stop the driving, and the switch 16 returns to an initial state. However, the present invention is not limited to this configuration. In addition, a slide-type switch or the like may be used instead of the push-type switch (not illustrated).

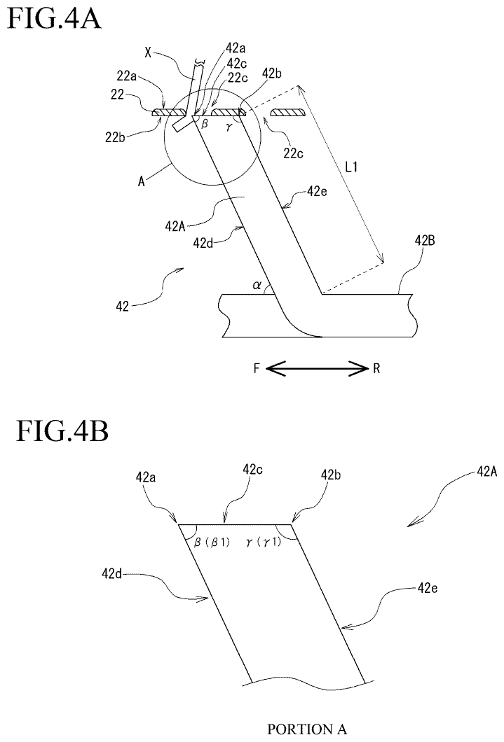

Next, an example of the inner blade 42 will be described in detail with reference to FIGS. 3, 4A, and 4B. FIG. 3 is a perspective view illustrating an example of the inner blade 42. In addition, FIG. 4A is an enlarged view of the small blade 42A of the inner blade 42, and FIG. 4B is an enlarged view of a portion A in FIG. 4A. In each drawing, with regard to rotation directions of the inner blade 42, a rotation direction of forward rotation is indicated by a direction of an arrow F, and a rotation direction of rearward rotation is indicated by a direction of an arrow R.

As illustrated in FIG. 3, the inner blade 42 according to the present embodiment is configured to include a plurality of the small blades 42A in which a portion of a metal plate is erected from a plate surface 42B (for simplification of the drawing, reference numerals are assigned only to some of the small blades 42A). As an example, the small blade 42A is erected and formed such that an angle α of an angle (erection angle) on a front side in the rotation direction with respect to the plate surface 42B of the metal plate is an acute angle.

In the present embodiment, the inner blade 42 is formed as an integrated structure in such a manner that die cutting and bending are performed through press working by using a metal plate made of stainless steel. In this way, since the inner blade 42 can be formed with a simple structure and with fewer steps, it is possible to reduce component costs and assembly costs. However, the present invention is not limited to the integrated structure.

As an example, the small blade 42A according to the present embodiment has a substantially rectangular prism shape having a rectangular cross section in which one side is approximately 1 mm and the other side is approximately 0.5 mm, and is formed to have a length L1 of approximately 3 mm. However, a size and a shape are not limited. In addition, when the length L1 is further shortened, stiffness of the small blade 42A can be improved, and occurrence of deflection or vibration can be prevented during an operation. Therefore, cutting quality is improved.

In addition, in the small blade 42A, the first blade edge 42a that can cut the hair-like body X entering the hair-like body inlet 22c is formed on a tip side in the forward rotation direction in an upper end portion, and the second blade edge 42b that can cut the hair-like body X entering the hair-like body inlet 22c is formed on a tip side in the rearward rotation direction in the upper end portion.

More specifically, in the small blade 42A, an upper end edge defined by a tip side surface (hereinafter, referred to as a “first end surface”) 42d in the forward rotation direction and an upper end surface 42c serves as the first blade edge 42a that cuts the hair-like body X in the forward rotation direction. On the other hand, an upper end edge defined by a tip side surface (hereinafter, referred to as a “second end surface”) 42e in the rearward rotation direction and the upper end surface 42c serves as the second blade edge 42b that cuts the hair-like body X in the rearward rotation direction.

In addition, in the present embodiment, the small blade 42A is configured such that the upper end surface 42c connecting the first blade edge 42a and the second blade edge 42b is in sliding contact with the inner surface 22b of the outer blade 22. Here, an angle (rake angle) of the first blade edge 42a of the small blade 42A is defined as an angle β (β1), and an angle (rake angle) of the second blade edge 42b is defined as an angle γ (γ1). In the present embodiment, the small blade 42A having two types of angles (rake angles) is realized by forming an angle β (β1) to be an angle relatively smaller than an angle γ (γ1) and forming an angle γ (γ1) to be an angle relatively larger than the angle β (β1). As illustrated in FIGS. 4A and 4B, the configuration of the small blade 42A is extremely simplified. Accordingly, the small blade 42A can be formed by fewer steps, compared to the configuration in the related art.

According to this configuration, when the inner blade 42 is rotated forward (rotated in an F direction), the first blade edge 42a of the small blade 42A can cut the hair-like body X entering the hair-like body inlet 22c of the outer blade 22. That is, the hair-like body X can be cut by the blade edge (here, the first blade edge 42a) having a relatively sharp rake angle. Therefore, an advantageous effect of improving the cutting quality is obtained. However, since the blade edge has the sharp rake angle, damage to a base portion of the hair-like body relatively increases. A mode in which the inner blade 42 is rotated forward to cut the hair-like body X with the first blade edge 42a of the small blade 42A in this way, that is, a mode in which the improvement of the cutting quality is emphasized will be referred to as a “first mode”.

On the other hand, when the inner blade 42 is rotated rearward (rotated in an R direction), the second blade edge 42b of the small blade 42A can cut the hair-like body X entering the hair-like body inlet 22c of the outer blade 22. That is, the hair-like body X can be cut with the blade edge (here, the second blade edge 42b) having a rake angle which is not relatively sharp. Therefore, damage to the base portion of the hair-like body relatively decreases. However, since the blade has the rake angle which is not sharp, the cutting quality is relatively poor. A mode in which the inner blade 42 is rotated rearward to cut the hair-like body X with the second blade edge 42b of the small blade 42A in this way, that is, a mode in which suppressing the damage to the base portion is emphasized will be referred to as a “second mode”.

Here, the present inventor has intensively studied setting a specific angle in the inner blade 42 (small blade 42A). As a result, the present inventor has confirmed the followings. When using the inner blade 42 having the small blade 42A in which the angle α is formed to be 35°≤α<90°, the angle β (β1) is formed to be 35°≤β1<90°, and the angle γ (γ1) is formed to be 90°<γ1≤145°, the cutting quality can be improved during the forward rotation, and the damage to the base portion can be reduced during the rearward rotation. The angle α may be set to 90° or larger.

The present inventor has confirmed that the above-described advantageous effects are more significantly obtained when more preferably using the inner blade 42 having the small blade 42A in which the angle α is formed to be 60°≤α<90°, the angle β (β1) is formed to be 60°≤β1<90°, and the angle γ (γ1) is formed to be 90°<γ1≤120°.

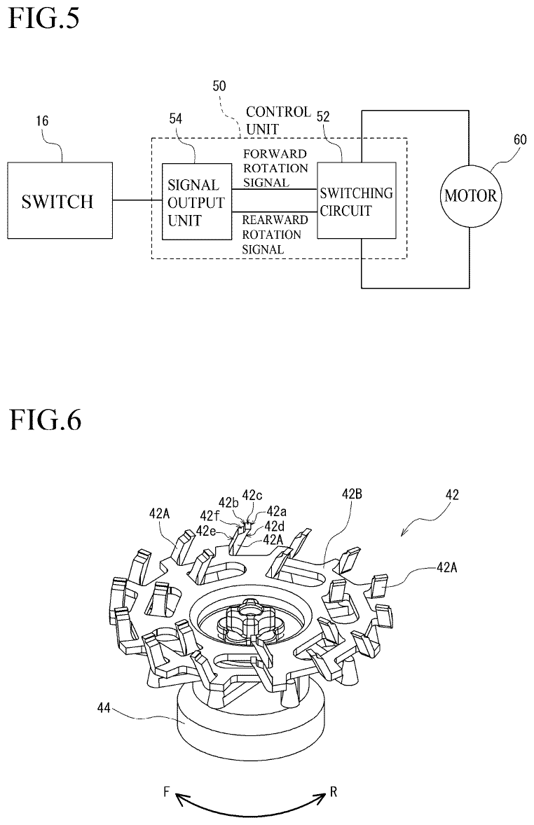

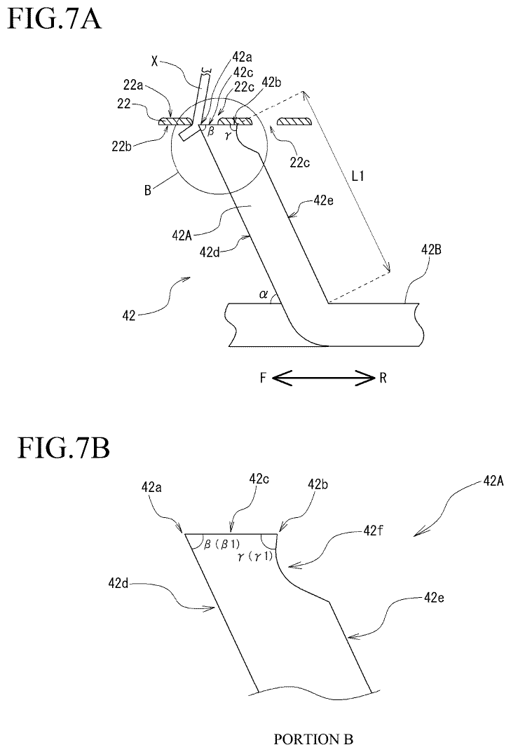

Next, another example of the inner blade 42 will be described in detail with reference to FIGS. 6, 7A, and 7B. FIG. 6 is a perspective view illustrating an example of the inner blade 42. In addition, FIG. 7A is an enlarged view of the small blade 42A of the inner blade 42, and FIG. 7B is an enlarged view of a portion B in FIG. 7A. The basic configuration is the same as that of the inner blade 42 illustrated in FIGS. 3, 4A, and 4B. Therefore, different points will be mainly described.

In the second end surface 42e of the inner blade 42 according to this example, a recess portion 42f having a shape cut from the upper end surface 42c toward the lower end is provided. The upper end edge defined by the recess portion 42f and the upper end surface 42c serves as the second blade edge 42b. Therefore, when the recess portion 42f is formed to be large (deep) in a circumferential direction, an area of the upper end surface 42c can be reduced. Therefore, sliding resistance can be reduced.

Here, a shape of the recess portion 42f is not particularly limited, and for example, as in the examples illustrated in FIGS. 7A and 7B, the whole recess portion 42f may be formed in a curved shape, or may have a shape (not illustrated) including a plurality of flat surfaces and a curved surface connecting the flat surfaces. A method for forming the recess portion 42f is not particularly limited, and the recess portion 42f can be formed by various processing methods such as press processing, cutting (grinding) processing, electric discharge processing, and electrochemical machining (ECM).

In the inner blade 42 according to this example, the angle β (β1) is formed to be relatively smaller than the angle γ (γ1), and the angle γ (γ1) is formed to be relatively larger than the angle β (β1). For example, the angle β (β1) is formed to be 35°≤β1<60°, and the angle γ (γ1) is formed to be 60°≤γ1<90°. In the present embodiment, even when the angle α of the erection angle of the small blade 42A is formed as an acute angle by the configuration provided with the recess portion 42f, the angle γ (γ1) of the rake angle of the second blade edge 42b can be formed as the acute angle. Therefore, when the second blade edge 42b is used, cutting with further improved cutting quality can be performed, compared to the second blade edge 42b having the configuration illustrated in FIGS. 3, 4A, and 4B. In addition, since the shape of the recess portion 42f is appropriately set, the rake angle γ (γ1) of the second blade edge 42b can be set to any angle.

Subsequently, setting a rotation speed of the inner blade 42 will be described.

First, as a premise, the blade edge (first blade edge 42a) during the forward rotation (first mode) is set to further improve the cutting quality of the hair-like body X. In view of this configuration, the following has been confirmed. When using the inner blade 42 having the configuration set to the angles α, β, and γ as described above, it is preferable to set the rotation speed of the inner blade 42 in the second mode to be higher than the rotation speed of the inner blade 42 in the first mode.

Specifically, it has been confirmed that in the rotation speed of the inner blade 42 during the rearward rotation (second mode) approximately exceeding 1.2 times the rotation speed of the inner blade 42 during the forward rotation (first mode), the cutting quality of the hair-like body X during the rearward rotation is not significantly inferior to the cutting quality in the first mode. On the other hand, it has been confirmed that in the rotation speed of the inner blade 42 during the rearward rotation (second mode) approximately exceeding 1.8 times the rotation speed of the inner blade 42 during the forward rotation (first mode), the damage to the base portion during the rearward rotation cannot be significantly reduced, compared to the first mode.

Therefore, it is preferable that the rotation speed of the inner blade 42 in the second mode is set to be 1.2 to 1.8 times the rotation speed of the inner blade 42 in the first mode.

In addition, as a modification example, the rotation speed may be set in a plurality of stages in both or one of the first mode and the second mode.

Furthermore, as another mode, when a predetermined operation (for example, an operation for pressing the switch a predetermined number of times) of the switch 16 or the like is performed, the control unit 50 may perform control such that the signal output unit 54 alternately outputs a signal indicating that the rotation direction of the inner blade 42 is the forward rotation direction and a signal indicating that the rotation direction of the inner blade 42 is the rearward rotation direction, to the switching circuit 52 at a predetermined time interval. Accordingly, a usage mode (a “third mode”) in which the “first mode” and the “second mode” are automatically switched and repeated at a predetermined time interval can be used. Therefore, it is possible to realize a usage method in which the hair-like body X in a lying state is raised by the “second mode” and is deeply cut by the “first mode”.

In addition to the above-described operational effects, when the “first mode” is used, the second blade edge 42b on a rear end side in the rotation direction is brought into sliding contact with the inner surface 22b of the outer blade 22 to be dragged. In this manner, an operation for sharpening the second blade edge 42b (tip portion) is performed. Therefore, when used in the “second mode” after the “first mode”, an advantageous effect of further improving the cutting quality of the hair-like body X by the second blade edge 42b is obtained.

Similarly, when used in the “second mode”, the first blade edge 42a on the rear end side in the rotation direction is brought into sliding contact with the inner surface 22b of the outer blade 22 to be dragged. In this manner, an operation for sharpening the first blade edge 42a (tip portion) is performed. Therefore, when used in the “first mode” after the “second mode”, an advantageous effect of further improving the cutting quality of the hair-like body X by the first blade edge 42a is obtained.

### Second Embodiment

Next, an electric cutter 1 (1B) of the hair-like body according to a second embodiment of the present invention will be described.

As an example of the electric cutter 1 (1B) of the hair-like body according to the present embodiment, an “electric lint remover” when the hair-like body as a cutting target is a “lint” will be described.

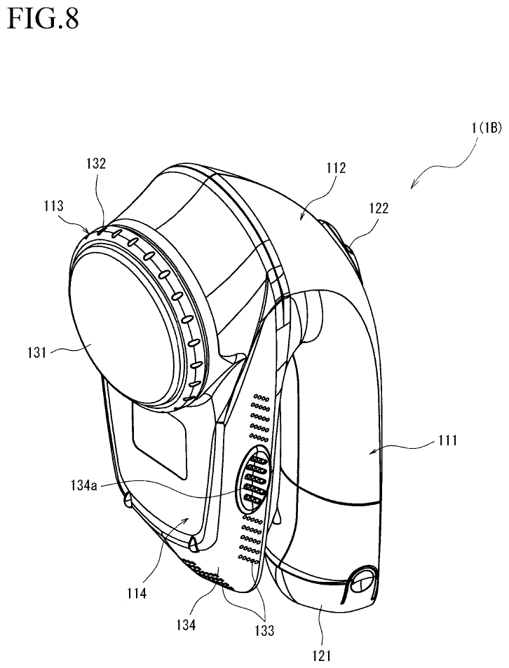

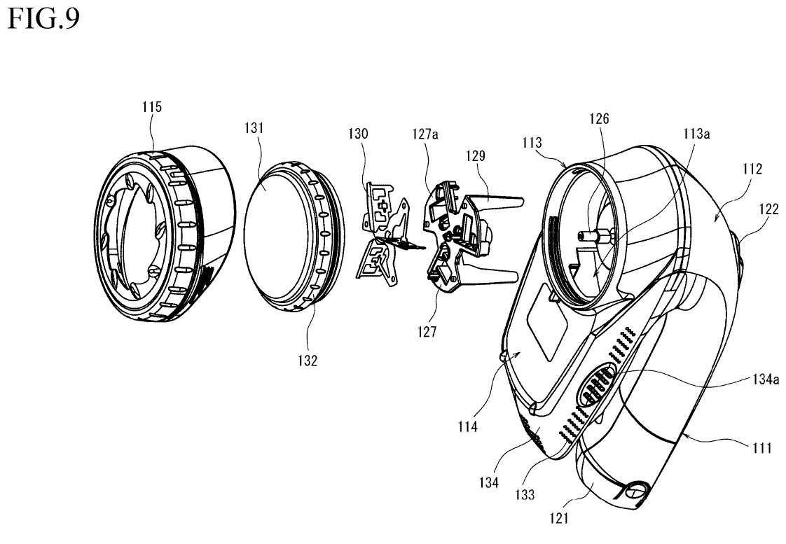

FIG. 8 is a schematic view (perspective view) illustrating an example of the electric cutter 1 (1B) of the hair-like body according to the present embodiment. In addition, FIG. 9 is a schematic view (exploded perspective view) illustrating an example of the electric cutter 1 (1B) of the hair-like body.

A main body (main body case) of the electric cutter 1 (1B) of the hair-like body has a U-shape or a J-shape in a side view. In the electric cutter 1 (1B) of the hair-like body, the main body side includes a handle unit 111, a neck unit 112, a head unit 113 (blade portion) that mainly cuts the lint, and a dust accommodation unit 114 that accommodates scraps of the cut lint or the like.

The handle unit 111 is formed to be easily gripped when the electric cutter 1 (1B) of the hair-like body is used. The electric cutter 1 (1B) of the hair-like body includes a battery (not illustrated) as a drive power source inside the handle unit 111. In addition, the electric cutter 1 (1B) of the hair-like body includes a lid portion 121 on one end portion side of the handle unit 111. The battery may be either a dry battery or a rechargeable battery.

The neck unit 112 is provided on the other end portion side of the handle unit 111. The electric cutter 1 (1B) of the hair-like body includes a switch 122 outside the neck unit 112 and a motor, a control unit, or the like inside the neck unit 112 (not illustrated).

In the electric cutter 1 (1B) of the hair-like body, the electric cutter is configured such that power can be supplied from the battery to the motor by operating the switch 122. The motor switches the polarities to rotate an inner blade 130 in the forward rotation direction (direction indicated by an arrow F in the drawing) and the rearward rotation direction (direction indicated by an arrow R in the drawing) opposite to the forward rotation direction. A motor joint 126 connected to a connection tool 127 (to be described later) is fixed to the inner blade 130.

The switch 122 is provided to be capable of reciprocating, for example, among three positions of upper, middle, and lower stages in order to switch the usage mode of the electric cutter 1 (1B) of the hair-like body depending on a state of the base portion (that is, the fabric), a size of the hair-like body (that is, the lint), or the like. In the electric cutter 1 (1B) of the hair-like body, for example, the switch 122 switches a normal mode (first mode) at the upper stage position, a stop mode at the middle stage position, and a soft mode (second mode) at the lower stage position. In the usage mode of the electric cutter 1 (1B) of the hair-like body, the rotation direction of the inner blade 130 is different. For example, the inner blade 130 rotates in the forward rotation direction (F direction) in the normal mode, and the inner blade 130 rotates in the rearward rotation direction (R direction) in the soft mode. It is preferable that the normal mode is used for a thick fabric having a large lint, and the soft mode is used for a thin fabric having a small lint. In this case, it is preferable that the rotation speed of the inner blade 130 in the soft mode is set to be higher than the rotation speed of the inner blade 130 in the normal mode.

The head unit 113 is provided at a position ahead of the neck unit 112 from the handle unit 111 side. The electric cutter 1 (1B) of the hair-like body includes the connection tool 127 and the inner blade 130 inside the head unit 113, and an outer blade 131 outside the head unit 113.

The connection tool 127 is an inner blade support tool that has an installation surface 127a on which the inner blade 130 is provided and that rotatably supports the inner blade 130. The connection tool 127 includes a shaft tube 128 fitted to the motor joint 126 to stop the rotation. The shaft tube 128 of the connection tool 127 is connected to a rotary shaft (not illustrated) of the motor extending into the head unit 113 via the motor joint 126.

The inner blade 130 is provided to be rotatable in the forward rotation direction (F direction) and the rearward rotation direction (R direction) by a motor (not illustrated) to switch the polarities of the motor via the connection tool 127. The inner blade 130 is attachable to and detachable from the motor joint 126 in the axial direction (extending direction of the axis) in a state of being attached to the connection tool 127 (also referred to as an inner blade set).

In addition, the outer blade 131 is attachable to and detachable from the head unit 113 in a state of being attached in a dome shape to a ring-shaped cap portion 132 which can be screwed to the head unit 113 (also referred to as an outer blade set). The outer blade 131 has a hair-like body inlet 131a, and is provided to cover the inner blade 130. For example, in a state where the inner blade 130 is rotated, the inner blade 130 is in contact with the inner surface of the outer blade 131, and the hair-like body (lint) entering the hair-like body inlet 131a of the outer blade 131 is cut by the inner blade 130, and is taken into the head unit 113 as it is.

The dust accommodation unit 114 is provided on a lower side of the head unit 113. The inside of the head unit 113 and the inside of the dust accommodation unit 114 communicate with each other via an opening portion 113a of the head unit 113. The lint taken in by the head unit 113 is fed into the dust accommodation unit 114 together with an air flow generated by the rotation of the connection tool 127 (fan). The connection tool 127 has a fan piece 129 for generating the air flow on a side opposite to a side where the inner blade 130 is provided.

The dust accommodation unit 114 includes a dust box 134 having an air hole 133. Since the air hole 133 is provided, the air flow is easily generated from the head unit 113 to the dust accommodation unit 114. The dust box 134 is configured to be slidably attached to and detached from the dust accommodation unit 114. When the dust box 134 is filled with the lint, for example, the dust box 134 can be slid down and detached by hooking a finger on a finger hooking portion 134a, and the lint can be discarded.

When the lint is removed (cut) by using this electric cutter 1 (1B) of the hair-like body, first, in the fabric of sweaters, clothes, socks, blankets, or the like, a portion where the lint is to be removed is placed on a flat surface, and wrinkles of the fabric are stretched. Next, the switch 122 is turned on (normal mode or soft mode). Next, the head unit 113 is operated along the fabric to remove (cut) the lint.

In this way, for example, the electric cutter 1 (1B) of the hair-like body includes a function of the normal mode (first mode) in which the inner blade 130 rotates in the forward rotation direction (F direction) to prioritize the cutting ability (improvement of the cutting quality), and a function of the soft mode (second mode) in which the inner blade 130 rotates in the rearward rotation direction (R direction) to prioritize protection (suppressing damage) of the fabric. That is, in the electric cutter 1 (1B) of the hair-like body, a user can prevent the fabric from being perforated by performing a switching operation for switching (selecting) the rotation direction of the inner blade 130 in accordance with an application (usage state). That is, since the user can switch (select) a plurality of modes with one device in accordance with the application, it is possible to deal with various clothing fabrics without perforation, and thus, convenience is improved.

In addition, the rotation direction of the inner blade 130 is switched, and the lint is cut from each on both surface sides of the inner blade 130. Accordingly, durability of the inner blade 130 can be improved. Therefore, even when the electric cutter 1 (1B) of the hair-like body is used many times, it is possible to remove (cut) the lint with hardly damaging the fabric.

As an accessory, the electric cutter 1 (1B) of the hair-like body may include a ring-shaped fabric guard 115 (refer to FIG. 9) that is attachable to and detachable from the head unit 113. The fabric guard 115 can adjust an interval between a surface of the outer blade 131 and the fabric, depending on a state of the fabric or a size of the lint. Since the fabric guard 115 is used, it is possible to further prevent the fabric from being damaged.

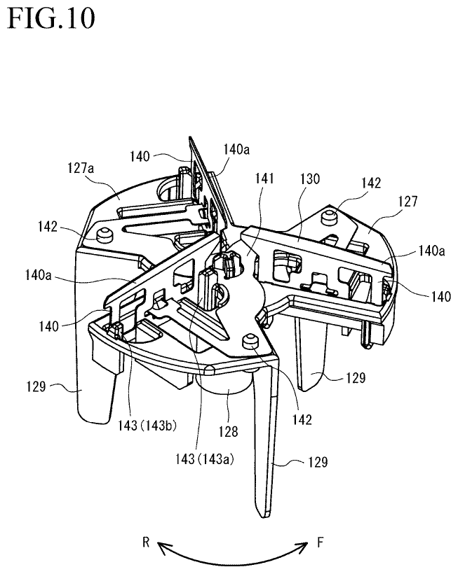

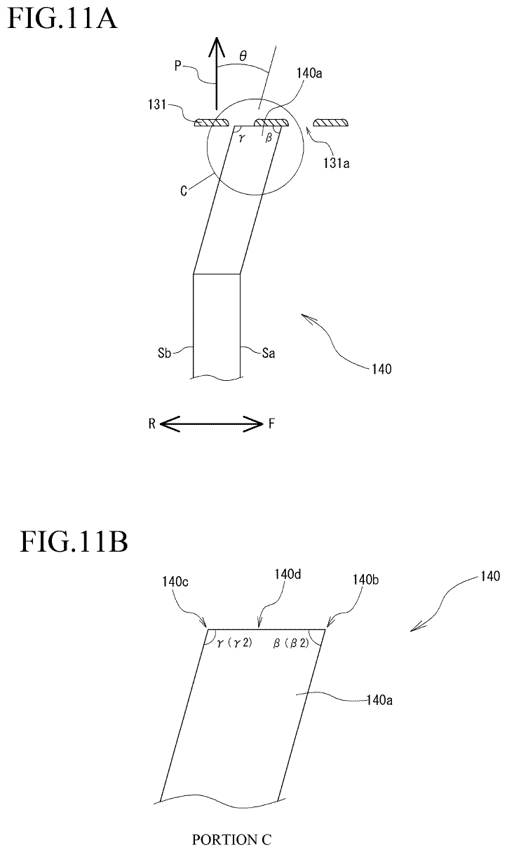

Next, a configuration, an operation, and the like of the blade unit of the electric cutter 1 (1B) of the hair-like body, that is, the inner blade 130 and the outer blade 131 will be described in detail. Here, FIG. 10 is a perspective view illustrating an example of the inner blade 130. In addition, FIG. 11A is an enlarged view of a small blade 140 of the inner blade 130, and FIG. 11B is an enlarged view of a portion C in FIG. 11A.

The inner blade 130 in a state of being attached to the connection tool 127 has the plate-shaped small blade 140 provided in a plane parallel to the axial direction (passing through the rotation center) of the connection tool 127 in which the shaft tube 128 serves as the rotary shaft. The inner blade 130 has an edge portion 140a on the inner surface side of the outer blade 131 in the small blade 140. A plurality of (three in the present embodiment) small blades 140 in the inner blade 130 are provided at an equal interval in a circumferential direction to be radial (in a radial direction) from the rotation center.

In addition, the inner blade 130 is configured as follows. The small blade 140 is elastic with respect to the inner surface of the outer blade 131 such that the edge portion 140a is in contact with the inner surface of the outer blade 131. Specifically, the inner blade 130 has a plate-shaped arm portion 141 provided in a plane orthogonal to the axial direction of the rotary shaft (passing through the rotation center). The arm portion 141 is provided to be separated into a plurality of (three in an equal interval in the circumferential direction in the present embodiment) portions from the rotation center to correspond to the small blade 140. The small blade 140 is provided in a tip portion of the arm portion 141 to be vertically erected. The inner blade 130 is attached to the connection tool 127 by a fixing tool 142 in an intermediate portion of the arm portion 141 which is branched from the rotation center side.

In the present embodiment, as illustrated in FIG. 11A, the inner blade 130 is bent such that the edge portion 140a of the small blade 140 in the direction parallel to an axial direction P (length direction of the shaft tube 128) of the rotary shaft is inclined forward in the forward rotation direction (F direction) of the inner blade 130.

Specifically, the edge portion 140a (tip portion) is bent at a bending angle θ from a portion of the small blade 140 on the connection tool 127 side in the direction parallel to the axial direction P. The small blade 140 has a surface Sa on the side in the forward rotation direction (F direction) and a surface Sb on the side in the rearward rotation direction (R direction), and the edge portion 140a is bent to be valley-folded on the surface Sa side (mountain-folded on the surface Sb side).

Here, as illustrated in FIG. 11B, in the small blade 140, an upper end edge on the tip side in the forward rotation direction of the edge portion 140a is a first blade edge 140b that cuts the hair-like body in the forward rotation direction. On the other hand, an upper end edge on the tip side in the rearward rotation direction is a second blade edge 140c that cuts the hair-like body in the rearward rotation direction.

In addition, in the present embodiment, the small blade 140 is configured such that an upper end surface 140d connecting the first blade edge 140b and the second blade edge 140c is in sliding contact with the inner surface of the outer blade 131. Here, an angle (rake angle) of the first blade edge 140b of the small blade 42A will be referred to as an angle β (β2), and an angle (rake angle) of the second blade edge 140c will be referred to as an angle γ (γ2). In the present embodiment, the small blade 140 having two types of angles (rake angles) is realized by forming the angle β (β2) to be relatively smaller than the angle γ (γ2) and forming the angle γ (γ2) to be relatively larger than the angle β (β2).

Since the above-described configuration is provided, in the normal mode in which the inner blade 130 is rotated in the forward rotation direction (F direction), the edge portion 140a (first blade edge 140b) having the small angle β (β2) of the rake angle rotates ahead (pierces the inner surface of the outer blade 131). Therefore, for example, even a large lint can be easily removed (cut). On the other hand, in the soft mode in which the inner blade 130 is rotated in the rearward rotation direction (R direction), the edge portion 140a (second blade edge 140c) having the large angle γ (γ2) of the rake angle is rotated to follow later (strokes the inner surface of the outer blade 131). Therefore, it is possible to prevent the fabric from being caught by the inner blade 130, the fabric is hardly damaged, and the lint can be removed (cut). In this way, in the electric cutter 1 (1B) of the hair-like body according to the present embodiment, compared to the normal mode, the soft mode is a mode in which there is a less burden on the fabric and perforation or the like is prevented.

In the present embodiment, the angle θ is formed to be θ=10°. It is preferable to adopt a configuration in which the angle is formed to be 5°≤θ≤10° (however, the present invention is not limited thereto). The reason is that a difference between the soft mode and the normal mode is small when the bending angle θ of the edge portion 140a is smaller than 5°. In addition, the reason is as follows. When the bending angle θ of the edge portion 140a is larger than 10°, cutting ability for cutting the lint is degraded even when the inner blade 130 rotates in the rearward rotation direction (R direction). In this way, the modes can be differently used depending on the difference in the rotation directions of the inner blade 130. However, a function of each mode can be preferably secured by setting the bending angle θ of the edge portion 140a to 5°≤θ≤10°.

In addition, in view of the above-described settings of the angle θ, in the present embodiment, the angle β (β2) of the first blade edge 140b is formed to be 80°≤β2≤85°, and the angle γ (γ2) of the second blade edge 140c is formed to be 95°≤γ2≤100° (however, the present invention is not limited thereto).

In addition, in the present embodiment, the electric cutter 1 (1B) of the hair-like body includes a support portion 143 that protrudes from the installation surface 127a of the connection tool 127 and supports the small blade 140 of the inner blade 130 from the side in the forward rotation direction (F direction). As described above, since the edge portion 140a is bent at the bending angle θ, the edge portion 140a follows later when the inner blade 130 rotates in the rearward rotation direction (R direction). Therefore, when the inner blade 130 rotates, the small blade 140 may be excessively inclined, and thus, the cutting ability to cut the lint may degraded. In this regard, since the support portion 143 is provided, it is possible to prevent a possibility that the small blade 140 is excessively inclined when the inner blade 130 rotates, and that the cutting ability to cut the lint is degraded.

Here, it is more preferable that the support portion 143 includes an inner support portion 143a provided near the rotation center (center of the shaft tube 128) and an outer support portion 143b provided far from the rotation center, and that a height of the inner support portion 143a is higher than a height of the outer support portion 143b. According to this configuration, the height of the inner support portion 143a is increased on the rotation center side closer to the fabric when removing (cutting) the lint. In this manner, it is possible to prevent a possibility that the small blade 140 of the inner blade 130 on the rotation center side is excessively inclined due to the rotation, and that the cutting ability to cut the lint is degraded.

In addition, in the present embodiment, as illustrated in FIG. 10, the connection tool 127 has a plate-shaped fan piece 129 provided in a plane parallel to the axial direction (passing through the rotation center) of the connection tool 127 in which the shaft tube 128 serves as the rotary shaft, on a back surface opposite to the installation surface 127a where the inner blade 130 is provided. That is, the connection tool 127 has a function as a fan. A plurality of (three in the present embodiment) fan pieces 129 are provided at an equal interval in the circumferential direction to be radial (in the radial direction) from the rotation center.

According to this configuration, the fan piece 129 rotates at the same angle (90° which is vertical) with respect to the rotation direction even when the connection tool 127 rotates in the rearward rotation direction (R direction) or rotates in the forward rotation direction (F direction). Therefore, inside the head unit 113 provided with the connection tool 127, even when the connection tool 127 rotates in any direction, the generated air flow is directed toward the dust accommodation unit 114 side, and it is possible to prevent a possibility that the lint cut from the fabric is discharged outward from the outer blade 131.

As described above, according to the electric cutter of the hair-like body in the present invention, it is possible to realize cutting emphasizing the improvement of the cutting quality during the forward rotation (first mode). Furthermore, during the rearward rotation (second mode), it is possible to realize cutting in which suppressing damage to the base portion is emphasized and the cutting quality is not significantly inferior to the cutting quality in the first mode. Therefore, it is possible to provide the electric cutter of the hair-like body which can realize a plurality of types of cutting suitable for a user's preference, a state of the hair-like body (length, amount, or the like), and a state of the base portion (damage state or the like) by using only one type of the inner blade and without setting a plurality of rotation speeds in each of the forward rotation and the rearward rotation.

The present invention is not limited to the embodiments described above, and various modifications can be made within the scope not departing from the present invention. In particular, the number (number of units) of combinations (blade units) of the outer blade and the inner blade is not particularly limited.

What is claimed is:

1. An electric cutter of a hair-like body, comprising:
a blade unit having an outer blade having a plurality of hair-like body inlets, and an inner blade rotating while coming into sliding contact with an inner surface of the outer blade,
wherein the inner blade has a plurality of small blades, and is provided to be rotatable in a forward rotation direction and a rearward rotation direction,
the small blade has a first blade edge configured to cut a hair-like body entering the hair-like body inlet on a tip side in the forward rotation direction of an upper end portion, and has a second blade edge configured to cut the hair-like body entering the hair-like body inlet on a tip side in the rearward rotation direction of the upper end portion,
the electric cutter further includes switching means for switching rotation directions of the inner blade to switch between a first mode in which the hair-like body is cut by the first blade edge and a second mode in which the hair-like body is cut by the second blade edge, and
a rotation speed of the inner blade in the second mode is set to be higher than a rotation speed of the inner blade in the first mode.

2. The electric cutter of a hair-like body according to claim 1, wherein the small blade is formed such that an angle β of a rake angle of the first blade edge is a relatively small angle, and is formed such that an angle γ of a rake angle of the second blade edge is a relatively large angle.

3. The electric cutter of a hair-like body according to claim 2, wherein the small blade is formed such that the angle β of the rake angle of the first blade edge is an acute angle, and is formed such that the angle γ of the rake angle of the second blade edge is an obtuse angle.

4. The electric cutter of a hair-like body according to claim 3, wherein the rotation speed of the inner blade in the second mode is set to be 1.2 to 1.8 times the rotation speed of the inner blade in the first mode.
